(19) United States
(12) Patent Application Publication
(10) Pub. No.: US 2014/0067801 A1
(43) Pub. Date: Mar. 6, 2014

(54) GEOTAGGING BASED ON SPECIFIED CRITERIA

(71) Applicants: David L. MARVIT, San Francisco, CA (US); Jawahar JAIN, Los Altos, CA (US); Ajay CHANDER, San Francisco, CA (US); Alex GILMAN, Fremont, CA (US)

(72) Inventors: David L. MARVIT, San Francisco, CA (US); Jawahar JAIN, Los Altos, CA (US); Ajay CHANDER, San Francisco, CA (US); Alex GILMAN, Fremont, CA (US)

(73) Assignee: FUJITSU LIMITED, Kawasaki-shi (JP)

(21) Appl. No.: 13/601,706

(22) Filed: Aug. 31, 2012

(51) Int. Cl. G06F 17/30

(52) U.S. Cl. 707/736; 707/E17.009

(57) ABSTRACT

A method of geotagging based on specified criteria is described. The method may include analyzing a data stream indicating a variable parameter associated with an object to determine data within the data stream satisfying a specified criteria. The method may also include obtaining geospatial information for the object or another object corresponding to a time the data was generated. Relevant data collected at the time the data satisfies the specified criteria may be tagged with the geospatial information. Related systems are also described.

### FIELD

The embodiments discussed herein are related to geotagging data based on one or more specified criteria.

### BACKGROUND

Geotagging is the process of adding location data to photographs or other media, enabling users to easily and accurately know where in the world the media was captured. For example, a geotag may be added to a photograph to show the location of a camera that captured the photograph at the time the photograph was taken. The geotag is often associated with media as metadata and may be added to any media format such as photographs, video, websites, SMS messages, and RSS feeds. The location data provided by the geotag may include latitude, longitude or other information capable of specifying the location. The geotag associates a particular location with the media at the time it was generated and is, thus, useful in finding location-specific information.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a system of geotagging based on specified criteria is described. The system may include a first sensor configured to generate data indicating a variable parameter associated with a first object. The system may also include a second sensor configured to generate geospatial information of the first object. The system may also include a computing device configured to perform operations including: receiving the data from the first sensor; determining whether a specified criteria is met based at least in part on the data; and tagging the data with geospatial information generated by the second sensor when the specified criteria is met.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a schematic block diagram illustrating an embodiment of a system of geotagging information based on specified criteria;

FIG. 2 is a flowchart of an example method of geotagging information based on specified criteria;

FIG. 3 is a flowchart of an example method of geotagging information from one sensor or sensor system based on specified criteria received from another, different sensor or sensor system; and

FIG. 4 is a block diagram illustrating an example computing device that is arranged for geotagging information based on specified criteria in accordance with the present disclosure.

### DESCRIPTION OF EMBODIMENTS

Some embodiments described herein generally relate to methods and systems of geotagging based on one or more specified criteria. As used herein, the term “geotagging” and “geotagged” may refer to associating geospatial data with one or more geographical locations related to the data. The geospatial data may include, for example, latitude and longitude coordinates, address information, zip code information, altitude, direction, bearing, distance and place names. For example, data collected by one or more sensors may be analyzed to determine whether the specified criteria are satisfied. The specified criteria may include a threshold value of the data or the presence of one or more indicators of a condition being analyzed. The data that satisfies the specified criteria may be geotagged by associating the data with geospatial information related to the data. As used herein, the term “geospatial” may refer to geographic data referencing a place or a location relative to the Earth's surface. For example, the geospatial data may be collected with or at the same time as the data. The data and the associated geospatial data may be stored and/or shared with one or more third parties.

Embodiments of the present invention will be explained with reference to the accompanying drawings.

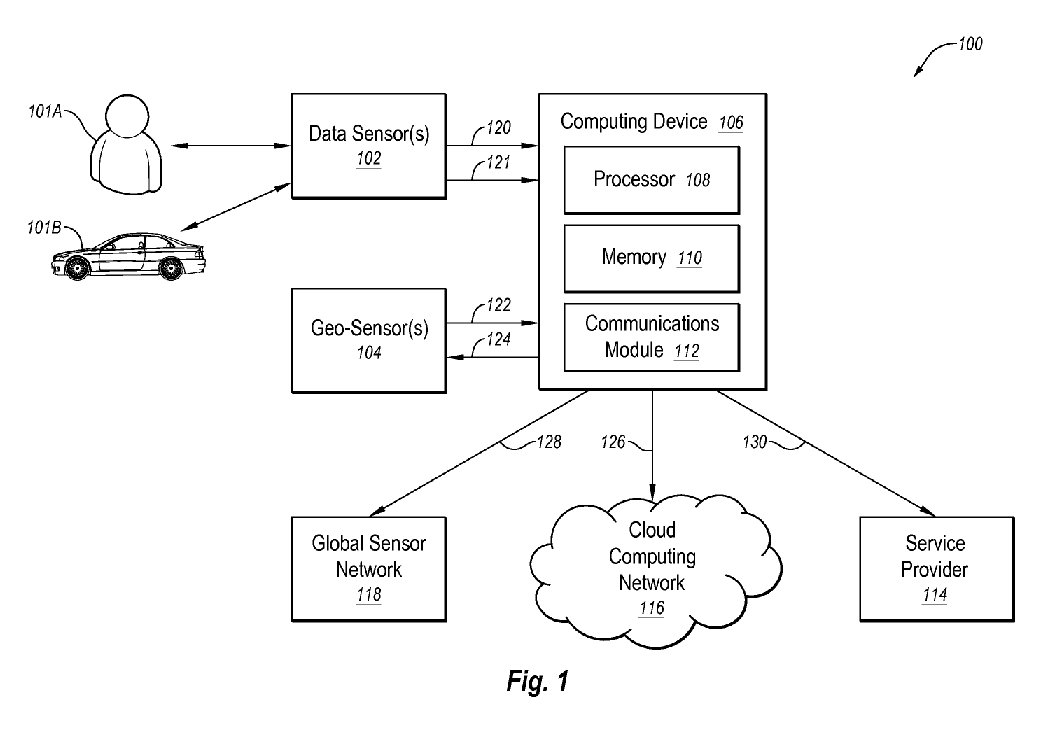

FIG. 1 is a schematic block diagram illustrating an embodiment of a system 100 for geotagging information based on one or more specified criteria. The system 100 may include a data sensor system 102, a geo-sensor 104 and a computing device 106.

The data sensor system 102 may include a single data sensor or multiple data sensors. Each data sensor system 102 may be configured to generate a first data stream 120 indicating a variable parameter associated with an object. As used herein, the term “variable parameter” may refer to a characteristic or factor capable of being altered over time. In some embodiments, the variable parameter may include at least one of a health condition of a person, such as stress levels, or a driving or road condition, as described herein.

The object may be any object of interest for which data may be obtained, such as a person 101A, a vehicle 101B, an animal (not shown), or the like (hereinafter generically “object 101”). The variable parameter may relate to any application in which the system 100 is used to apply a geotag to data related to the object 101. As used herein, the term “geotag” may refer to any type of geographical data or orientation data associated with content. As a non-limiting example, the system 100 may be used in assessing a health condition in the person 101A or a driving or road condition related to the vehicle 101B.

The data sensor system 102 may monitor data related to the variable parameter over a specified period of time. For example, the data sensor system 102 may be configured to monitor data related to an activity of the object 101, such as a function or movement of the object 101, and to generate the first data stream 120 including such data. In embodiments in which the object 101 is the person 101A or an animal, the data sensor system 102 may monitor one or more indicators of a physical, mental or emotional condition. For example, the indicator may be a biological or biochemical indicator, such as a biological function. The biological function may include cardiac function, dermal function, motor function, respiratory function, digestive function, and the like. As a non-limiting example, the biological function monitored by the data sensor system 102 may include a biological function linked to or associated with stress levels, such as stress level, heart rate (HR), heart rate variability (HRV), respiratory rates, respiratory volume (and its proxies), blood sugar level, skin conductance, temperature, posture, drowsiness, blink rate, eye tracking, eyelid occlusion and the like. For example, the drowsiness may be determined as measure by a variety of biological function including HRV, blink rate, eye tracking and eyelid occlusion. The data sensor system 102 may include, for example, a photoplethysmograph (PPG), electrocardiogram (ECG), an electromyogram (EMG), an electroencephalogram (EEG), an electronystagmogram (ENG), a galvanic skin response (GSR) sensor, an ohmmeter, a biofeedback monitor, a cardio-respiratory belt, a carbon dioxide sensor, an oxygen sensor, a thermometer, eye tracking system, LIDAR systems, RADAR systems, video cameras, gyroscopes, magnetometers and the like.

In embodiments in which the object 101 is the vehicle 101B, the data sensor system 102 may monitor activity related to automotive condition, an acceleration of the vehicle, a condition of a component of the vehicle, external traffic, driving hazards and roadway conditions. By way of example and not limitation, the data sensor system 102 may monitor one or more of distance to other vehicles, closing speed with other vehicles, traffic conditions, road signs and traffic lights, road conditions, visibility conditions, forward velocity, lateral velocity, momentary acceleration, braking capabilities, driver state and behavior, and the like. As another non-limiting example, the data sensor system 102 may monitor a condition of the environment around the vehicle such as weather, road conditions, traffic, air quality and the like. For example, the data sensor system 102 may include one or more radar detectors, optical sensors, laser distance sensors, smart video and accelerometers.

The data sensor system 102 may include a mobile sensor that enables collection of data as the object 101 moves from one location to another. The data sensor system 102 may therefore be carried by the object 101, such as in a pocket, a purse, on a lanyard or a belt, or may be attached or secured to the object 101 such that the data may be continuously monitored as the object 101 changes locations. For example, in embodiments in which the object 101 is the person 101A, the data sensor system 102 may monitor the biological function of the person 101A during activities in which the person 101A may participate over the period of time. Such activities may include, but are not limited to, working, commuting, driving, walking, relaxing, meditating, eating, sleeping, or the like or any combination thereof.

The geo-sensor 104 may be configured to generate a second data stream 122 including geospatial information related to the object 101. For example, the geo-sensor 104 may identify and generate the geospatial location of the object 101. To determine the geospatial location and/or orientation, the geo-sensor 104 may employ a global positioning system (GPS) receiver or other satellite receiver, a cellular network, a WLAN network, a magnetometer, an accelerometer and the like. The second data stream 122 generated by the geo-sensor 104 may describe the geospatial location and/or orientation of the object 101, of the geo-sensor 104 itself and/or of the system 100.

The computing device 106 may be configured to receive the first data stream 120 from the data sensor system 102 and to process the first data stream 120 to determine data relevant to the application based on the specified criteria. For example, the computing device 106 may continuously receive the first data stream 120 from the data sensor system 102 and may monitor the first data stream 120 to determine the data. The computing device 106 may also be configured to receive the second data stream 122 from the geo-sensor 104. The computing device 106 may continuously receive the second data stream 122 from the geo-sensor 104, or may communicate with the geo-sensor 104 via a request 124 to obtain the second data stream 122 as desired. For example, the computing device 106 may transmit the request 124 to the geo-sensor 104 to request geospatial data upon determining that the second data stream 122 generated at a particular time contains relevant data. The geo-sensor 104 may transmit the geospatial data of the object 101 at the particular time such that the relevant data may be tagged with the geospatial data. The tagged data may be used in analysis, as will be described in further detail.

As a non-limiting example, the data sensor system 102 and the geo-sensor 104 may be located remotely from the computing device 106. The computing device 106 may communicate with the data sensor system 102 and the geo-sensor 104 over one or more networks, such as the Internet, telephony networks, cellular networks, data networks, satellite networks, 802.11 networks, personal computer networks, wireless networks and the like. The computing device 106 may include a communications module 112 configured for communicating with external devices, such as the data sensor system 102 and the geo-sensor 104. For simplicity, the data sensor system 102 and the geo-sensor 104 are shown in FIG. 1 as being external to the computing device 106. However, the data sensor system 102 and the geo-sensor 104 may optionally be integrated with the computing device 106.

When implemented at least partially in software, the computing device 106 may include a processor 108 and a memory 110 configured to execute computer instructions stored in the memory 110 to cause the computing device 106 to perform the operations described herein, such as collection of data from the data sensor system 102 and the geo-sensor 104, geotagging of the data satisfying the specified criteria, analysis of the data and transmittal of the data to third parties. The communications module 112 may enable the computing device 106 to communicate with the data sensor system 102 and the geo-sensor 104 as well as with one or more external networks, such as a service provider 114, a cloud computing network 116 and/or a global sensor network 118.

The computing device 106 may also be configured to determine whether the specified criteria is met based at least in part on the data stream 120 from the data sensor system 102. The specified criteria may be the presence of the indicator is detected. The specified criteria may be, for example, a threshold value that may be compared with the first data stream 120 collected by the data sensor system 102, or a change in value of the first data stream 120 collected by the data sensor system 102. The threshold value may include a specific sensor value or range of values that does not reflect a specific and/or temporally correlated user intent.

The specified criteria may be set based on attributes associated with a particular application in which the system 100 is used. The specified criteria may also be set by a user of the system 100 or an administrator of the system 100. The specified criteria may be changed over time based on machine learning or through communication with other networked systems.

The specified criteria may trigger the computing device 106 to associate the geotag with relevant data from the first data stream 120 with geospatial information generated by the geo-sensor 104 when the specified criteria is met. For example, the computing device 106 may be configured to associate the geotag with the relevant data when the specified criteria is met.

The processor 108 may process the first data stream 120 according to a particular application in which the system 100 is used and may utilize processed data to determine whether the one or more indicators being monitored by the data sensor system 102 is present or whether the specified criteria is met. As a non-limiting example, the system 100 may be used to monitor stress levels of the person 101A and the first data stream 120 may be analyzed or processed to determine whether the first data stream 120 includes relevant data such as data indicating the stress level of the person 101A has exceeded a threshold value or otherwise met a specified criteria. As another non-limiting example, the system 100 may be used to monitor stress levels of the person 101A while operating a vehicle, such as a train, and the first data stream 120 may be analyzed or processed to determine the locations at which the person 101A exhibits increased stress levels—and hence may have an increased risk of being involved in an accident. To monitor stress levels while the person 101A is driving, one or more of a photoplethysmograph, an ECG, a camera, a GSR detector, and an accelerometer may be used in the data sensor system 102. If the stress level of the person 101A is determined to be above the threshold value, then the geospatial data associated with the person 101A at that point in time may be captured and associated with the corresponding relevant data from the data stream 120 generated by the data sensor system 102.

The data sensor system 102 may include a plurality of sensors, each configured for monitoring different variable parameters, such as those related to the person 101A, the vehicle 101B, or any other physical quantity. A first sensor or sensor system of the data sensor system 102 may be used to monitor a first variable parameter and a second sensor or sensor system of the data sensor system 102 may be used to monitor a second variable parameter. The data sensor system 102 may include any number of sensors or sensor systems for measuring any number of variable parameters. For example, the first sensor or sensor system may monitor stress levels of the person 101A while operating a vehicle, such as a train, and the second sensor or sensor system may be used to monitor road conditions experienced by the vehicle 101B. The first sensor or sensor system may generate the first data stream and the second sensor or sensor system may generate a second data stream 121. The system 100 may include any number of sensors or sensor systems that may generate any number of data streams.

The first and second data streams 120 and 121 may be received by the processor 108 and the processor 108 may analyze at least one of the first and second data streams 120 and 121 to determine if the specified criteria is met. If the specified criteria is met for the first data stream 120, the second data stream 121 collected at the time the first data stream 120 meets the specified criteria may be tagged with geospatial data. For example, the first data stream 120 may be analyzed to determine if the stress levels of the person 101A meet the specified criteria. If the stress level of the person 101A monitored by one of the sensors is determined to be above the threshold value, then the geospatial data associated with another sensor, such as a sensor associated with the vehicle 101B, at that point in time may be captured and associated with the corresponding relevant data, such as the data from the second data stream 121. Additionally or alternatively, if data in the second data stream 121 associated with the vehicle 101B is determined to be above the threshold value, then the geospatial data associated with the person 101A, who may be in the vehicle 101B may be captured at that point in time and associated with the corresponding relevant data from the first data stream 120. Accordingly, data from the first sensor or sensor system may be used to determine points in time in which data from the second sensor or sensor system should be associated with the geospatial data. It will be understood that the first data stream 120 may include data collected from the vehicle 101B.

The relevant data from one or more data streams, such as the first data stream 120 and/or the second data stream 121, is thus generated at the time the specified criteria is met and may then be stored and/or geotagged using the geospatial location obtained from the geo-sensor 104 to generate geotagged data.

The geotagged data may be generated by the processor 108 and may be stored on the memory 110, for example. As a non-limiting example, the geotagged data may be stored on the memory 110 of the computing device 106, or may be transmitted and stored on an external network, such as the cloud computing network 116. As another non-limiting example, one or more geotagged data streams 126, 128 and 130 may be generated and respectively transmitted to the cloud computing network 116, the global sensor network 118 and the service provider 114. The geotagged data streams 126, 128 and 130 may be transmitted by the communications module 112 of the computing device 106. The geotagged data streams 126, 128 and 130 may include the geotagged data and/or analytic information determined based on the geotagged data. For example, the geotagged data may relate to the stress level of the person 101A while driving and such information may be processed to provide a first geotagged data stream 128 including information relevant to a global sensor network 118 that disseminates information about driving conditions and to provide a separate geotagged data stream 130 including information relevant to the service provider 114, such as a physician. The geotagged data, which includes the geographic information and/or orientation data of the object 101 at the time the relevant data was generated, may thus facilitate analysis of the application in which the system 100 is used.

The system 100 is illustrated in FIG. 1 as including a single data sensor system 102 configured to transmit the first data stream 120 to the computing device 106. However, the system 100 may include any number of data sensors or data sensor systems, each configured to generate a data stream and transmit the data stream to the computing device 106. For example, the computing device 106 may be configured to receive at least another data stream from at least another data sensor and to derive a value or a set of values from the first data stream and the at least another data stream. In these and other embodiments, determining whether the specified criteria is met based at least in part on the first data stream may include determining whether the specified criteria is met based on the derived value or set of values.

For example, the system 100 may be used to continuously track one or more biological functions of the person 101A. The relevant data collected by the system 100 may be analyzed to determine stresses experienced by the person 101A or fitness, attentiveness, or arousal of the person 101A in real-time. For example, the computing device 106 may monitor the first data stream 120 generating information about a health condition, such as heart rate or heart rhythm, of the person 101A and may analyze the data to determine relevant data indicating an irregular heart rate or irregular heart rhythm. The information about the health condition of the person 101A may be monitored during a particular activity or event, such as work, driving, exercise and the like. The relevant data may be geotagged and the geotagged data may be transmitted to the service provider 114 enabling the service provider 114, such as a physician or other healthcare professional, an employer, a patient or a government entity to use the information for the purposes of analysis or dissemination.

In another example, the system 100 may be used to continuously track conditions related to the vehicle 101B. The relevant data collected by the system 100 may be analyzed to determine the conditions experienced by the vehicle 101B in real-time. For example, the computing device 106 may monitor the first data stream 120 generating information about driving or road conditions related to a travel route of the vehicle 101B. The computing device 106 may analyze the first data stream 120 to determine relevant data and may associate the geotag with the relevant data to generate the geotagged data. For example, the first data stream 120 may generate data related to traffic or diving conditions experienced by the vehicle 101B. As the computing device 106 receives the first data stream 120 from the data sensor system 102, the computing device 106 may analyze the first data stream 120 to determine if the specified criteria are satisfied. For example, the computing device 106 may recognize a specified criteria indicating the vehicle hit a patch of ice has been met, and may associate a geotag with that data. The geotagged data may be transmitted for storage on the cloud computing network 116 or for dissemination by the global sensor network 118.

The geotagged data may be analyzed to provide analytics and recommendations. In an example embodiment, the computing device 106 may generate the geotagged data when stress levels for the person 101A are a specified percentage above normal during a particular activity, such as driving to work. The geotagged data thus indicates locations at which the person 101A feels most stressed during the activity. The geotagged data may be used to provide recommendations to the person 101A to reduce their stress levels, such as a different route or locations at which to change speed or use caution.

In an example embodiment, the computing device 106 may generate the geotagged data when the data sensor system 102 in the vehicle 101B indicates a potential road hazard, such as unsafe road conditions, an accident or slowing of traffic. The geotagged data, which includes information about the location of the potential road hazard, may be relayed to other vehicles directly using the global sensor network 118, or may be transmitted to the cloud computing network 116.

Thus, the system 100 provides analytics related to the particular application based on real-time data identified and geotagged in response to satisfying the particular criteria. Additionally, the system 100 enables collection of the relevant information without user input or monitoring.

Accordingly, the computing device 106 may be configured to process the geotagged data to provide detailed information about the mental, physical or emotional state of the person 101A during certain time periods or during certain activities. Such information may be shared with the person 101A or the service provider 114 and may be used to improve the person's 101A health. As another non-limiting example, the computing device 106 may be configured to process the geotagged data to provide detailed information about the driving conditions experienced by the vehicle 101B. Such information may be shared, for example, with other drivers or with agencies using the global sensor network 118. For example, government agencies or car manufacturers may use the geotagged data generated by the system 100 to develop more intelligent and responsive vehicles, such as those capable of managing information delivery in the context of the driver's situation.

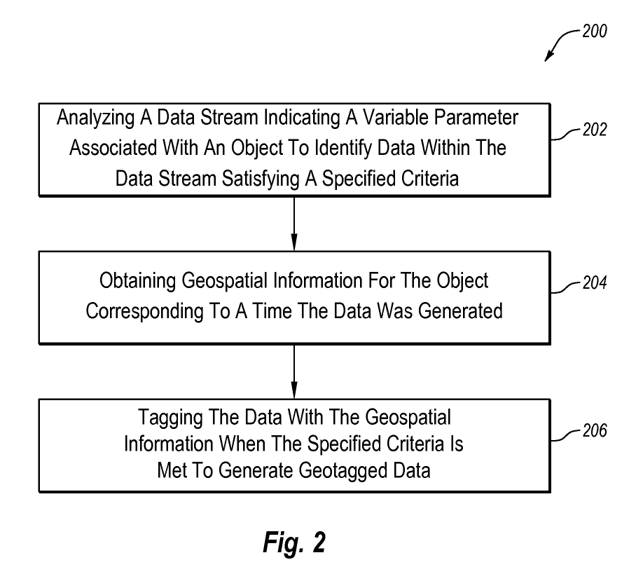

FIG. 2 is a flowchart of an example method of geotagging information based on specified criteria. The method 200 and/or variations thereof may be implemented, in whole or in part, by a system, such as the system 100 described herein. Alternately or additionally, the method 200 and/or variations thereof may be implemented, in whole or in part, by a processor or other processing device using data generated by data sensors and geo-sensors, such as the processor 108 of FIG. 1. Although illustrated as discrete blocks, various blocks may be divided into additional blocks, combined into fewer blocks, or eliminated, depending on the desired implementation.

The method 200 may begin at block 202 in which a data stream indicating a variable parameter associated with an object is analyzed to identify data within the data stream satisfying a specified criteria. For example, the data stream may be received by the computing device 106 from the data sensor system 102 and then analyzed by the computing device 106.

In block 204, geospatial information for the object corresponding to a time the data was generated may be obtained. For example the geospatial information may be obtained by the computing device 106 from the geo-sensor 104. Optionally, the computing device 106 may transmit a request for the geospatial information to the geo-sensor 104 after the data satisfying the specified criteria is identified.

In block 206, the data may be tagged with the geospatial information when the specified criteria is met to generate geotagged data. For example, the computing device 106 may associate a geotag with the data obtained from the data sensor system 102. Optionally, the geotagged information may be transmitted by the computing device 106 to one or more third parties.

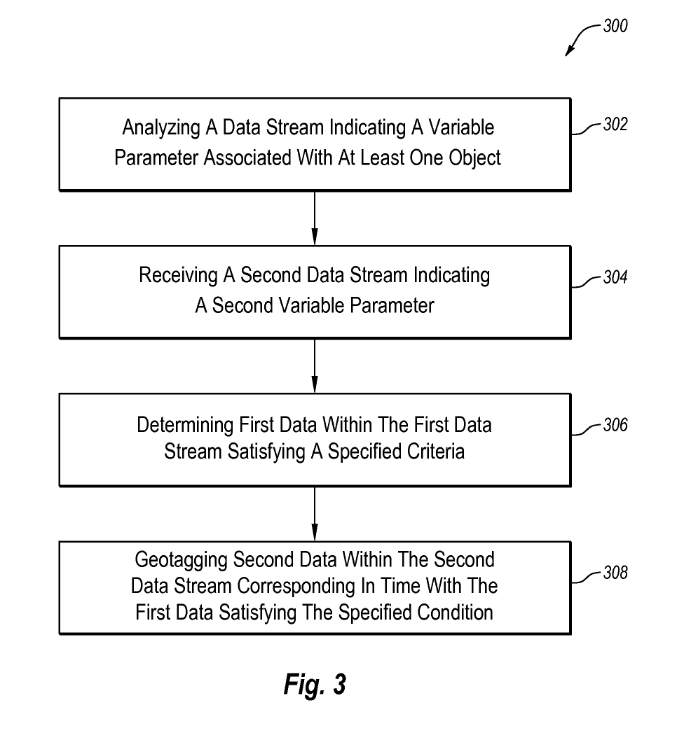

FIG. 3 is a flowchart of an example method of geotagging information from one sensor or sensor system based on specified criteria received from another, different sensor or sensor system. The method 300 and/or variations thereof may be implemented, in whole or in part, by a system, such as the system 100 described herein. Alternately or additionally, the method 300 and/or variations thereof may be implemented, in whole or in part, by a processor or other processing device using data generated by data sensors and geo-sensors, such as the processor 108 of FIG. 1. Although illustrated as discrete blocks, various blocks may be divided into additional blocks, combined into fewer blocks, or eliminated, depending on the desired implementation.

The method 300 may begin at block 302 in which a data stream indicating a first variable parameter associated with at least one object may be analyzed. For example, the first data stream may be received by the computing device 106 from a first sensor or sensor system of the data sensor system 102 and may then be analyzed by the computing device 106.

In block 304, a second data stream indicating a second variable parameter may be received. The second data stream may be associated with the object, such as a person, or another object, such as a vehicle. For example, the geospatial information may be obtained by the computing device 106 from a second sensor or sensor system of the data sensor system 102. The second variable parameter may be related to the first variable parameter. For example, the first variable parameter may be a stress level of the person who is driving the vehicle and the second variable parameter may be at least one of a driving speed, road condition and location of the vehicle while the person is driving.

In block 306, first data within the first data stream satisfying a specified criteria may be determined. For example, the processor 108 of the computing device 106 may analyze the first data stream to determine the first data which satisfies the specified criteria, such as a threshold value. For example, the threshold value for a biological function determinative of the stress level of the person may be met while the person is driving the vehicle, thus the data collected at that time satisfies the specified criteria.

In block 308, second data within the second data stream corresponding in time with the first data satisfying the specified condition may be geotagged. For example, the geotagging may include tagging the second data with geospatial information related to the second data. The geospatial information may be obtained by the computing device 106 from the geo-sensor 104. Optionally, the computing device 106 may transmit a request for the geospatial information to the geo-sensor 104 after the data satisfying the specified criteria is identified. For example, the computing device 106 may associate a geotag with the second data obtained from the data sensor system 102. Optionally, the geotagged information may be transmitted by the computing device 106 to one or more third parties. As a non-limiting example, the second data may include data related to the vehicle while the person is driving the vehicle, such as a driving speed, road condition and location of the vehicle. The second data collected at the same time that the first data satisfies the specified criteria may be tagged with geospatial information.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

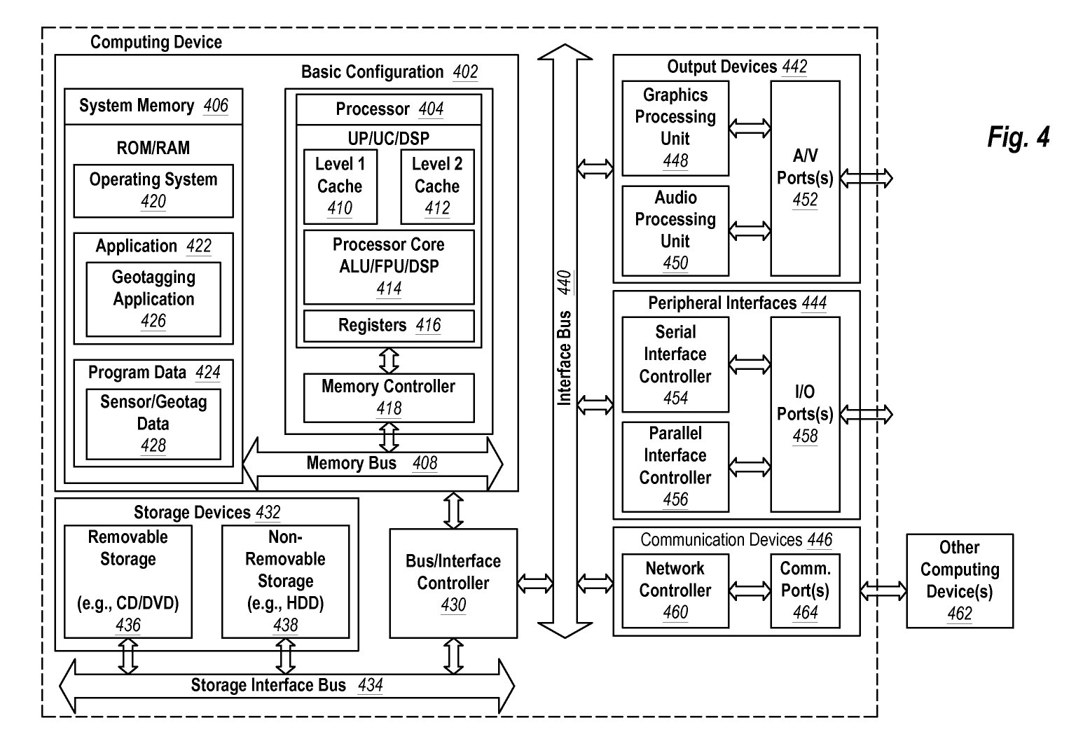

FIG. 4 is a block diagram illustrating an example computing device 400 that is arranged for geotagging information based on specified criteria in accordance with the present disclosure. The computing device 400 is one example of an embodiment of the computing device 106 of FIG. 1. In a very basic configuration 402, computing device 400 typically includes one or more processors 404 and a system memory 406. A memory bus 408 may be used for communicating between processor 404 and system memory 406.

Depending on the desired configuration, processor 404 may be of any type including but not limited to a microprocessor (μP), a microcontroller (μC), a digital signal processor (DSP), or any combination thereof. Processor 404 may include one more levels of caching, such as a level one cache 410 and a level two cache 412, a processor core 414, and registers 416. An example processor core 414 may include an arithmetic logic unit (ALU), a floating point unit (FPU), a digital signal processing core (DSP Core), or any combination thereof. An example memory controller 418 may also be used with processor 404, or in some implementations memory controller 418 may be an internal part of processor 404.

Depending on the desired configuration, system memory 406 may be of any type including but not limited to volatile memory (such as RAM), non-volatile memory (such as ROM, flash memory, etc.) or any combination thereof. System memory 406 may include an operating system 420, one or more applications 422, and program data 424. Application 422 may include a geotagging application 426 that is arranged to perform the functions as described herein including those described with respect to the method 200 of FIG. 2. Program data 424 may include sensor/geotag data 428 that may be useful for operation with the geotagging application 426 as is described herein. In some embodiments, application 422 may be arranged to operate with program data 424 on operating system 420 such that sensor data from a data sensor may be geotagged based on specified criteria as described herein.

Computing device 400 may have additional features or functionality, and additional interfaces to facilitate communications between basic configuration 402 and other devices and interfaces. For example, a bus/interface controller 430 may be used to facilitate communications between basic configuration 402 and one or more data storage devices 432 via a storage interface bus 434. Data storage devices 432 may be removable storage devices 436, non-removable storage devices 438, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 406, removable storage devices 436 and non-removable storage devices 438 are examples of computer storage media. Computer storage media includes, but is not limited to, Random Access Memory (RAM), Read Only Memory (ROM), Electronically Erasable and Programmable Read Only Memory (EEPROM), flash memory or other memory technology, Compact Disc-Read Only Memory (CD-ROM), digital versatile disks (DVD) or other optical storage, magnetic cassettes, magnetic tape, magnetic disk storage or other magnetic storage devices, or any other medium which may be used to store the desired information and which may be accessed by computing device 400. Any such computer storage media may be part of computing device 400.

Computing device 400 may also include an interface bus 440 for facilitating communication from various interface devices (e.g., output devices 442, peripheral interfaces 444, and communication devices 446) to basic configuration 402 via bus/interface controller 430. Example output devices 442 include a graphics processing unit 448 and an audio processing unit 450, which may be configured to communicate to various external devices such as a display or speakers via one or more A/V ports 452. Example peripheral interfaces 444 include a serial interface controller 454 or a parallel interface controller 456, which may be configured to communicate with external devices such as input devices (e.g., keyboard, mouse, pen, voice input device, touch input device, etc.) or other peripheral devices (e.g., printer, scanner, etc.) via one or more I/O ports 458. An example communication device 446 includes a network controller 460, which may be arranged to facilitate communications with one or more other computing devices 462 over a network communication link via one or more communication ports 464.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 400 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 400 may also be implemented as a personal computer including both laptop computer and non-laptop computer configurations.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present inventions have been described in detail, it should be understood that the various changes, substitutions, and alterations could be made hereto without departing from the spirit and scope of the invention.

What is claimed is:

1. A system of geotagging based on specified criteria, the system comprising:
a first sensor configured to generate data indicating a variable parameter associated with a first object;
a second sensor configured to generate geospatial information of the first object; and
a computing device configured to perform operations comprising:
receiving the data from the first sensor;
determining whether a specified criteria is met based at least in part on the data; and
tagging the data with geospatial information generated by the second sensor when the specified criteria is met.

2. The system of claim 1, wherein the first sensor and the second sensor are located remotely from the computing device.

3. The system of claim 1, wherein the data is a first data stream and the variable parameter is a first variable parameter, the system further comprising a third sensor configured to generate a second data stream indicating a second variable parameter, wherein the operations further comprise:
receiving the second data stream from the third sensor; and
deriving a value or a set of values from both the first data stream and the second data stream;
wherein the determining whether the specified criteria is met is based at least in part on the first data stream and includes determining whether the specified criteria is met based on the derived value or set of values.

4. The system of claim 1, wherein the specified criteria is set by one or more of:
the system based on attributes associated with a particular application in which the system is used;
a user of the system; and
an administrator of the system.

5. The system of claim 1, wherein the computing device comprises a processing device configured to process the data according to a particular application in which the system is used, wherein the determining whether the specified criteria is met based at least in part on the data includes determining whether the specified criteria is met based on the processed data.

6. The system of claim 1, wherein the computing device is configured to continuously receive the data from the first sensor.

7. The system of claim 1, wherein:
the object comprises a vehicle or a person driving the vehicle; and
the variable parameter comprises one or more of:
activity related to automotive condition;
an acceleration of the vehicle;
a condition of a component of the vehicle;
a condition of the environment around the vehicle;
a heart rate of the person;
a blood sugar level of the person;
a breathing rate of the person; and
a stress level of the person.

8. A method of geotagging based on specified criteria, comprising:
analyzing a data stream indicating a first variable parameter associated with at least one object;
receiving a second data stream indicating a second variable parameter;
determining first data within the first data stream satisfying a specified criteria; and
geotagging second data within the second data stream corresponding in time with the first data satisfying the specified condition.

9. The method of claim 8, wherein the first data stream indicating a variable parameter associated with an object comprises a data stream indicating at least one indicator of stress levels in a person.

10. The method of claim 8, wherein the analyzing comprises analyzing the first data stream indicating the first variable parameter to identify first data having a value greater than or equal to a threshold value.

11. The method of claim 8, wherein the analyzing comprises continuously analyzing the first data stream indicating the first variable parameter to identify the first data in real-time.

12. The method of claim 8, wherein the receiving comprises receiving the second data stream indicating the second variable parameter from at least another object, wherein the second variable parameter is related to the first variable parameter.

13. The method of claim 8, further comprising:
continuously receiving the first data stream from a first sensor;
continuously receiving the second data stream from a second sensor; and
obtaining the geospatial information for the object from a third sensor remotely located from the first and second sensors.

14. The method of claim 8, wherein:
the at least one object comprises a vehicle or a person driving the vehicle; and
the variable parameter comprises one or more of:
an acceleration of the vehicle;
a condition of a component of the vehicle;
a condition of the environment around the vehicle;
a heart rate of the person;
a blood sugar level of the person;
a breathing rate of the person; and
a stress level of the person.

15. A processor configured to execute computer instructions to cause a system to perform operations to geotag data based on specified criteria, the operations comprising:
receiving data from at least one sensor, the data indicating a variable parameter associated with a first object;
determining whether a specified criteria is met based at least in part on the data; and
tagging, via another sensor, the data with geospatial information when the specified criteria is met.

16. The processor of claim 15, wherein the at least one sensor and the another sensor are located remotely from a computing device configured to determine whether the specified criteria is met.

17. The processor of claim 16, wherein the data is a first data stream and the variable parameter is a first variable parameter, the operations further comprising:
receiving, via a third sensor, a second data stream indicating a second variable parameter; and
deriving a value or a set of values from both the first data stream and the second data stream;
wherein the determining whether the specified criteria is met is based on at least the first data stream and includes determining whether the specified criteria is met based on the derived value or set of values.

18. The processor of claim 15, wherein the specified criteria is set by one or more of:
a system configured to record a geo-tag upon meeting the specified criteria based on attributes associated with a particular application in which the system is used;
a user of the system; and
an administrator of the system.

19. The processor of claim 15, the operations further comprising:
continuously receiving the data from the at least one sensor; and
identifying geographic locations where the specified criteria is met based on a frequency of meeting the specified criteria.

20. The processor of claim 15, wherein:
the object comprises a vehicle or a person driving the vehicle; and
the variable parameter comprises one or more of:
an acceleration of the vehicle;
a condition of a component of the vehicle;
a condition of the environment around the vehicle;
a heart rate of the person;
a blood sugar level of the person;
a breathing rate of the person; and
a stress level of the person.
